(19) United States
(12) Patent Application Publication
(10) Pub. No.: US 2008/0167390 A1
(43) Pub. Date: Jul. 10, 2008

(54) Defoamer composition for suppressing oil-based and water-based foams

(76) Inventors: James Archer, Sonora, TX (US); Daniel K. Durham, San Angelo, TX (US); George Thornton, San Angelo, TX (US)

Correspondence Address: JACKSON WALKER LLP, 901 MAIN STREET, SUITE 6000, DALLAS, TX, 75202-3797, US

(21) Appl. No.: 11/374,308

(22) Filed: Jun. 1, 2006

(51) Int. Cl. B01D 19/04

(52) U.S. Cl. 516/118; 516/116

(57) ABSTRACT

Defoamer compositions effective for the suppression of oil-based and water-based foams. The defoamer compositions comprise a fumed metal oxide, such as fumed silica, or another silica-based material dispersed in an organic solvent. The fumed metal oxide of silica-based material is preferably present at a low weight percentage and may be coated with polydimethylsiloxane (“PDMS”). The defoamer composition may also include one or more traditional defoamer compositions.

### BACKGROUND

This invention pertains to compositions that are effective defoamers for the suppression of oil-based and water-based foams. In particular, this invention pertains to fumed metal oxides and silica-based materials dispersed in solvent that function as effective defoamers, particularly in oil well applications.

Crude oil, gas, and water are produced in offshore platforms at high pressures, from about 1,000 to 10,000 psi, and passed through vessels designed to separate the oil and gas and also lower the pressure in steps to a level which can be handled by the pipeline. As the pressure drops, dissolved gas evolves and generates a foam which interferes with the separation of gas and liquid. Due to limited retention time, separation must be rapid for the vessels to function properly and chemical defoamers are used to realize maximum production rates.

An overview of the situation is given by Ian C. Callaghan in “Antifoams for Nonaqueous Systems in the Oil Industry,” Defoaming: Theory and Applications Ch. 2, P. R. Garrett, ed., 1993, pp. 11-150

In addition, a relatively new method for removing water from well bores is the use of foaming agents. The method is rapid and inexpensive, averaging about $5 per well treatment. Furthermore, only a lubricator or small pump is required for the treatment. Foaming agents form a light foam column when properly mixed with the water or brine in the well bore and agitated by even a small amount of gas from the formation. This lightened column is lifted from the well by gas pressure that is too low to lift a column of water. Furthermore, the foam is rigid and, by capturing gas in the form of small bubbles, prevents the gas from bypassing water in large casings.

The use of foamers to remove water can be problematic, however, as the presence of foam can interfere with the separation of gas from oil during production. Thus, defoamers must generally also be employed to remove any foam. U.S. Pat. No. 5,531,929 describes antifoam compositions containing silicone. U.S. Pat. No. 5,853,617 pertains to methods and compositions for suppressing oil-based foams and describes additional defoaming compositions.

Specific anti-foaming treatments can also be seen in patents such as U.S. Pat. No. 3,640,893, which relates to compositions for use in combating foam formation in aqueous systems comprised of a mineral base oil and 0.1 to 25% by weight of a fatty acid product resulting from the hydrolysis of a lipid extract.

Diorganopolysiloxane copolymers having a viscosity from 100,000 to 200,000,000 centipoise are described as useful defoamers in U.S. Pat. No. 3,974,120. Similarly, British Patent No. 1,543,596 also relates to diorganopolysiloxane copolymers said to be useful as defoamers. The entire content of each of these patents are hereby incorporated by reference.

There remains a need for new compositions and methods for suppressing foams that work more effectively and more cost effectively.

### SUMMARY

The present invention relates generally to the field of defoamer compositions. In particular, the defoamer composition of the current application is a fumed metal oxide or silica-based material that is dispersed in a solvent. The defoamer composition is particularly effective at suppressing oil-based and water-based foams, particularly those that are problematic in oil wells.

Generally, the current invention pertains to a defoamer composition. The defoamer composition comprises a fumed metal oxide, such as fumed silica, or a silica-based material dispersed in an organic solvent. Preferably, the fumed metal oxide or silica-based material is present at a very low weight percentage. The fumed metal oxide can be coated with a material such as polydimethyl siloxane. The defoamer composition can be used in association with other traditional defoamer compositions, such as non-fluorinated siloxane and fluorosilicones.

### DETAILED DESCRIPTION OF PREFERRED EMBODIMENTS

The present invention relates to a defoamer composition for the effective suppression of oil-based and water-based foams. The defoamer composition comprises a fumed metal oxide or silica-based material that is dispersed in an organic solvent and may be used in association with other traditional defoamers.

A first aspect of the present invention is a defoamer composition comprising a fumed metal oxide dispersed in an organic solvent. Another aspect of the invention is a defoamer composition comprising a silica-based material dispersed in an organic solvent. Preferably, the fumed metal oxide or the silica-based material is present at a low weight percentage. The defoamer composition may also further comprise one or more traditional defoamer compositions.

The fumed metal oxide is preferably fumed silica. The fumed silica is preferably dispersed in an organic solvent at a weight percentage of from about 0.02% to about 20%, more preferably from about 0.2% to about 1%, and even more preferably about 0.25%.

The silica-based material can be calcined silica micropowder, precipitated silica micropowder, silica aerogel, quartz micropowder, and fused silica micropowder. The silica based material is preferably dispersed in an organic solvent at a weight percentage of from about 0.02% to about 20%, more preferably from about 0.25% to about 1%, and even more preferably about 0.25%.

In a preferred embodiment, the fumed metal oxide or the silica-based material is coated with polydimethylsiloxane (“PDMS”) or a suitable inorganic phosphate or organic defoamer. An inorganic phosphate could be tetra potassium pyrophosphate and an organic defoamer could be a polypropylene glycol ester. In one preferred example, the fumed metal oxide is a hydrophobic fumed silica coated with PDMS such as AEROSIL® R202 (Degussa AG, Frankfurt, Germany). The AEROSIL® R202 fumed silica product has a specific surface area (BET) of 100±20 m²/g, a carbon content of 3.5-5.0 wt. %, an average primary particle size of 14 nm, an approximate tapped density value of 60 g/l, a moisture content (2 hours at 105° C.) of less than or equal to 0.5 wt. %, an ignition loss (2 hours at 1000° C., based on material dried for 2 hours at 105° C.) of 4.0-6.0 wt. %, a pH (in 4% dispersion) of 4.0-6.0, and a SiO₂ content (based on ignited material) of greater than or equal to 99.8 wt. %.

The organic solvent can be any suitable aliphatic, aromatic, or petroleum-based solvent. Specific examples include methyl isobutyl ketone, acetone, methyl ethyl ketone, Stoddard solvent, which is sold under trade names such as Texsolve S® (Texaco Chemical, Inc.) and Varsol 1® (ExxonMobil Chemical), kerosene, xylene, toluene, diesel, aliphatic refinery distillates, and combinations thereof.

Optionally, the defoamer composition can comprise a traditional defoamer composition, such as non-fluorinated siloxane or fluorosilicone. The non-fluorinated siloxane can be polydimethylsiloxane (“PDMS”). Any other defoamer composition known in the art can be used, as well as any combination of two or more defoamers.

The defoamer composition is prepared by mixing the fumed metal oxide or silica-based material with the organic solvent at ambient temperature. A static or dynamic mixer can be used to mix the composition. The fumed metal oxide or silica-based material does not dissolve in the organic solvent, but it does disperse. Coating the fumed metal oxide or silica-based material with polydimethylsiloxane (“PDMS”) makes it more dispersible in the organic solvent.

### Example 1

In one example, the defoamer compositions were tested on an offshore production platform receiving production from several different satellite wells. The total production comingled into a 3 phase separator. From that point, the oil was dumped into a heater treater, the water was sent to a free water knockout, and the gas was sent to a compressor. The total production was 6,000 bbls oil, 10,000 bbls water, and 12 MMCF gas.

Initial foaming problems presented themselves in the form of oil carryover and gas carry under into the low pressure separator resulting in high levels of fluid in the flare scrubber. A conventional defoamer consisting of polydimethylsiloxane (“PDMS”) in solvent was selected based on field and laboratory testing of the product. Testing indicated that this product would greatly reduce the foaming of the oil and would eliminate oil carryover. Injection of the conventional PDMS in solvent was marginally effective in stopping the foaming problem in the LP separator. To solve the problem of fluid carry over and gas carry under and to maximize performance, a defoamer composition consisting of a blend of about 0.02 weight percent of fumed silica in an kerosene was tested in place of the conventional defoamer at the same facility. The results were favorable. Field tests indicated that the fluid accumulated in the flare scrubber was greatly reduced.

### Example 2

In another example, the defoamer compositions were tested on an offshore production platform receiving production from several different satellite wells. The total production comingled into a 3 phase separator. From that point, the oil and water were dumped into a scrubber, and the gas was sent to a compressor. The total production was 6 bbls oil, 10 bbls water, and 1.2 MMCF gas.

Initial foaming problems presented themselves in the form of oil and water carryover to the compressor. A conventional defoamer consisting of polydimethylsiloxane (“PDMS”) in solvent was selected based on field and laboratory testing of the product. Testing indicated that this product would greatly reduce the foaming of the oil and would eliminate oil carryover. Injection of the conventional PDMS in solvent was marginally effective in stopping the foaming problem in the LP separator. To solve the problem of fluid carry over and gas carry under and to maximize performance, a defoamer composition consisting of a blend of about 0.02 weight percent of fumed silica in kerosene was tested in place of the conventional defoamer at the same facility. The results were favorable. Field tests indicated that the fluid accumulated in the flare scrubber was greatly reduced.

Many modifications may be made in the present invention without departing from the spirit and scope thereof which are defined only by the appended claims. For example, certain combinations of components thereof other than those specifically set out herein may be found by one of ordinary skill in the art to be particularly advantageous. Additionally, certain proportions of components may produce reaction products or proportions of reaction products having particular efficacy.

### REFERENCES CITED

The following U.S. Patent documents and publications are hereby incorporated by reference.

### U.S. Patent Documents

U.S. Pat. No. 3,640,893 to Forbes et al.
U.S. Pat. No. 3,974,120 to Razzano et al.
U.S. Pat. No. 4,329,528 to Evans
U.S. Pat. No. 4,411,806 to Tirtiaux et al.
U.S. Pat. No. 4,460,493 to Lomas
U.S. Pat. No. 4,537,677 to Keil
U.S. Pat. No. 4,557,737 to Callaghan et al.
U.S. Pat. No. 4,564,665 to Callaghan et al.
U.S. Pat. No. 4,577,040 to Kaufmann et al.
U.S. Pat. No. 5,354,505 to Mendoza
U.S. Pat. No. 5,397,367 to Fey et al.
U.S. Pat. No. 5,531,929 to Kobayashi et al.
U.S. Pat. No. 5,853,617 to Gallagher et al.

### Other Patent Documents

EP Patent No. 0167361
GB Patent No. 1543596
GB Patent No. 2234978
GB Patent No. 2244279

### Publications

Ian C. Callaghan, “Antifoams for Nonaqueous Systems in the Oil Industry,” Defoaming: Theory and Applications, Ch. 2, P. R. Garrett, ed., 1993, pp. 11-150.

What is claimed is:

1. A defoamer composition comprising a fumed metal oxide dispersed in an organic solvent.

2. The defoamer composition of claim 1, wherein the fumed metal oxide is fumed silica.

3. The defoamer composition of claim 1, wherein the fumed metal oxide is coated with an inorganic phosphate or an organic defoamer.

4. The defoamer composition of claim 1, wherein the fumed metal oxide is coated with polydimethylsiloxane (“PDMS”).

5. The defoamer composition of claim 1, wherein the organic solvent is methyl isobutyl ketone, acetone, methyl ethyl ketone, Stoddard solvent, kerosene, xylene, toluene, diesel, aliphatic refinery distillates, or combinations thereof.

6. The defoamer composition of claim 1, wherein the fumed metal oxide is present at a weight percentage, based on the weight of the entire composition, of about 0.05 to about 20%.

7. The defoamer composition of claim 1, wherein the fumed metal oxide is present at a weight percentage, based on the weight of the entire composition, of about 0.25%.

8. The defoamer composition of claim 1, further comprising a second defoamer.

9. The defoamer composition of claim 8, wherein the second defoamer is a non-fluorinated silicone or a fluorosilicone.

10. The defoamer composition of claim 8, wherein the second defoamer is polydimethylsiloxane (“PDMS”).

11. A method for suppressing oil-based and water-based foams comprising:
injecting into the foams the defoamer composition of claim 1.

12. A defoamer composition comprising a silica-based material dispersed in an organic solvent.

13. The defoamer composition of claim 12, wherein the silica-based material is calcined silica micropowder, precipitated silica micropowder, silica aerogel, quartz micropowder, or fused silica micropowder.

14. The defoamer composition of claim 12, wherein the fumed metal oxide is coated with an inorganic phosphate or an organic defoamer.

15. The defoamer composition of claim 12, wherein the silica-based material is coated with polydimethylsiloxane (“PDMS”).

16. The defoamer composition of claim 12, wherein the organic solvent is methyl isobutyl ketone, acetone, methyl ethyl ketone, Stoddard solvent, kerosene, xylene, toluene, diesel, aliphatic refinery distillates, or combinations thereof.

17. The defoamer composition of claim 12, wherein the silica-based material is present at a weight percentage, based on the weight of the entire composition, of about 0.05 to about 20%.

18. The defoamer composition of claim 12, wherein the silica-based material is present at a weight percentage, based on the weight of the entire composition, of about 0.25%.

19. The defoamer composition of claim 12, further comprising a second defoamer.

20. The defoamer composition of claim 19, wherein the second defoamer is a non-fluorinated silicone or a fluorosilicone.

21. The defoamer composition of claim 19 wherein the second defoamer is polydimethylsiloxane (“PDMS”).

22. A method for suppressing oil-based and water-based foams comprising:
injecting into the foams the defoamer composition of claim 12.
